(19) United States
(12) Patent Application Publication
(10) Pub. No.: US 2014/0100903 A1
(43) Pub. Date: Apr. 10, 2014

(54) AUTOMATED GROUP TRIALS OF PRODUCTS AND SERVICES

(71) Applicant: Zhongsheng Yuan, Bellevue, WA (US)

(72) Inventor: Zhongsheng Yuan, Bellevue, WA (US)

(21) Appl. No.: 14/049,226

(22) Filed: Oct. 9, 2013

Related U.S. Application Data
(60) Provisional application No. 61/711,261, filed on Oct. 9, 2012.

(51) Int. Cl. G06Q 30/06

(52) U.S. Cl. CPC G06Q 30/0601
USPC 705/7.18

(57) ABSTRACT

A group trial system is described herein that facilitates an automated group trial of various products or services. The system provides an online platform with distributed networks of local affiliates and consumer trial groups that enable consumers to easily locate, see or try products, or share related experiences directly with friends, before purchase. A trial group can check out trial products or a product as a group from the system. Then the trial products will be distributed directly among the group members according to the trial policy, trial setting and scheduling algorithms. The trial status of each group member and states of the trial products are tracked. After the group trial, the products may remain for further instruction, be consumed, be passed to next waiting group or returned to a designated location. This system provides a highly distributed, scalable, dynamic and extremely low-cost marketing/distributing platform.

### CROSS-REFERENCE TO RELATED APPLICATIONS

The present application claims priority to U.S. Patent Application No. 61/711,261 (Attorney Docket No. GROUPTRY001) entitled “LOCAL GROUP TRIAL NETWORKS,” and filed on Oct. 9, 2012, which is hereby incorporated by reference.

### BACKGROUND

Electronic commerce, commonly known as e-commerce, is a type of industry where the buying and selling of products or services is conducted over electronic systems such as the Internet and other computer networks. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web at least at one point in a transaction's life cycle, although e-commerce may encompass a wider range of technologies such as e-mail, mobile devices, social media, and telephones as well. Electronic commerce is generally considered the sales aspect of e-business. E-commerce also includes the exchange of data to facilitate the financing and payment aspects of business transactions.

Users of e-commerce often worry whether a product they see online will meet their expectations if they purchase the product. Brick and mortar retailers often are used as unintended showrooms for electronic purchases, where users will go visit a physical store to browse and test products, then go online to actually purchase the products (often at a lower price because the online retailer saves the cost of physical showrooms). Some products cannot be adequately tested even in a physical showroom. For example, a satellite television service might work differently in the user's home than at the store or as described online. Many products may not be carried in local stores and sold only online. Stores with the products may be far away and involve long distance driving. Purchases and returns are not convenient and costly in such scenarios.

Users dissatisfied with a purchase can lead to returns, negative word of mouth, and other costly and detrimental effects for a retailer or other seller of goods or services. On the other hand, users that are satisfied with a product or service can often become the greatest proponents of the product or service, which can lead to positive word of mouth and further sales for the seller. In the past, brands such as Mary Kay cosmetics and Tupperware food storage have used in home parties to sell products in a more intimate, home environment where friends can share experiences with the products. Even these types of sales events however cannot give the user an idea of how the product or service will behave for a particular person in that person's own home or their own usage environments.

### BRIEF DESCRIPTION OF THE DRAWINGS

FIG. 1 is a block diagram that illustrates components of the group trial system, in one embodiment.

FIG. 2 is a flow diagram that illustrates processing of the group trial system to schedule a group trial of an item, in one embodiment.

FIG. 3 is a flow diagram that illustrates processing of the group trial system to manage exchange of a trial item between members, in one embodiment.

### DETAILED DESCRIPTION

A group trial system is described herein that facilitates an automated group trial of various products or services. Online shopping is becoming ever more popular with online sales of $248B projected by 2014, in the United States. However, it has a major shortcoming, as consumers cannot see products before the purchase. Many consumers are hesitant to buy or easily prone to wrong or counterfeit products. Even in local shopping, many products are either unavailable or available only in selective stores at potentially inconvenient distances. The cost of returns and opportunity losses due to unsatisfied customers who end up keeping unwanted products are high for consumers, retailers, and manufacturers.

The group trial system provides an online service/platform with distributed local networks that enable consumers to easily see or try products locally, before purchase. The group trial system has three core services: 1) search/invite, which provides one-click access to find which local friends, trial groups, or businesses have the products that the consumer wants to try or see, or invite local friends to join a new or existing trial group, 2) trial/see, which allows the consumer to join or organize a trial group that directly shares and passes the products at work, school, home, or any convenient places (local partners support both group and individual trials), and 3) shopping with exclusive discounts or credits at local/online retail and manufacturing partners.

The group trial system allows consumers to easily try or see actual products before purchase, by directly sharing with local friends. Consumers can rely on trusted reviews or experience sharing from their own friends or trusted members to make the buy decision, even without actual trial. In some embodiments, the group trial system provides one-click access to find all local or online partners to shop rather than going to each store or site. The system can also provide savings through exclusive discounts, referral fees, and minimized costs from return, waste, or driving. The system provides a method of buying products that is sustainable, helpful, and social. Sustainable products are promoted with a sustainable trial process.

The group trial system provides manufacturers with distributed direct marketing/distribution networks of local consumer groups and partners that can help quickly enter any targeted market around the globe with competitive advantages, regardless of the company size. The system significantly reduces marketing, handling/shipping, and return costs. The system also significantly reduces new product failure rate via direct market tests at each phase of the product cycle.

The group trial system can be applied to sell virtually any type of product or service. Provided here are examples related to electronic gadgets, energy efficiency, and healthcare, though there are numerous others. IP TV and IP Phone subscription services are emerging markets with strong competition from Microsoft, Apple, Google, Comcast, ATT, and others. Service quality, features, and prices vary significantly. Consumer trial experience can have a big impact in such a market. The group trial system in this environment allows consumers to easily obtain demo set-top boxes and then simply plug-and play to select the service that meets the consumer's own needs, without actual purchase, any configuration, or switching providers. As another example, energy efficiency, green technology, and healthcare are global concerns, and top initiatives of most governments and large corporations. The group trial system employed in these environments can promote employee awareness, interests, and experience sharing, and then select the appropriate product, meeting each need, in a most cost effective way, with employee satisfaction and huge savings for the program sponsors.

The process of beginning a group trial usually begins with someone expressing an interest in ordering or booking a particular item. For example, a consumer shopping on the Internet may visit a website that provides offers to try products before a purchase. The consumer may also visit a physical store location that offers a computerized method for tracking in-home trials of products. A consumer could be invited to organize a trial group for a product either by local affiliate agent, own organization, or other trusted identify. In some embodiments, the consumer may at this point form a group for trying the product, or may allow the system to form a group. A group is a form of social network, tracked electronically by the group trial system, that provides accounting of who is trying which items, where the items are currently located, which group member is next scheduled to try the item, and so forth.

Next, the consumer receives the item for trial. Once the truncation request is approved and the asset is ready, the item or items are delivered and checked out to the consumer. Items may be delivered by mail, user pickup, shipping carrier, drop off from a previous trial member (e.g., of another group), and so forth. The transition of the item to the consumer causes the group trial system to update its accounting to note who currently has an instance of the item. The system may track many groups trying many instances of the same item contemporaneously.

When the consumer is done with the item, either because a fixed trial period has expired or because the consumer has indicated (e.g., by visiting a website to do so or running a mobile app for managing group trials) that the consumer is done, then the system begins a return/check-in process. A consumer checks in an item by returning the item to the affiliate, or by passing the item to a next trial member. If return is requested by the provider or requested by the consumer, the item will be returned by the consumer back to the provider's physical location, by email, drop-off, pickup, or other facility. In some cases, the system may direct the consumer to deliver the item to the next consumer designated for a trial of the item, as determined by the group trial system based on incoming requests for trials.

The group trial system provides numerous enhancements of and advantages over past systems. First, the group trial system provides a trial group as a tracking entity in software. A trial group includes multiple people that will each try the same product, and that typically have some connection between each other. For example, the group members may each belong to the same church, school, company, club, or live in the same region. The group members form a type of loose (or potentially very strong) social network. Second, the group trial system provides the management of passing physical products directly within the group using software tracking. This saves on shipping, driving, and other costs by finding convenient ways for group members to pass products to other group members. For example, members may simply bring the item somewhere they are already going, such as church, school, or other location, where the next group member also goes and can receive the item. During this passing, the group members may also share information such as the prior member sharing his or her experience with the product. This can shorten learning curves for more technical products and provides an added degree of comfort for the group members.

The group trial system provides a social network within the trial group with trial scheduling and information sharing exposure within the group and exposure to the public, according to privacy settings. For example, group members may share online reviews, discussion forums, and other resources related to products they have tried. These resources may be available to group members as well as members of other groups or potential future members of groups that would like to try the same product. Unlike past trial systems, users of the group trial system are aware of one another by default (can be turned off), and this awareness is used to benefit consumers and manufacturers by decreasing costs, increasing comfort, and so forth as discussed further herein. Thus, the group trial system provides an improved experience for consumers to be exposed to products and for manufacturers to obtain a broader reach for their products at lower cost.

The group trial system can provide multiple service types, including group try, group rental, and group library/toolbox, or any other similar service. A local affiliate network as used herein refers to all local affiliates including various retailers, businesses, service providers, non-profit organizations, corporations (employers), small stores, and home businesses. Each local affiliate can have its own catalog of items, associated assets, service/scheduling policy, and so forth. Assets (e.g., trial items) can be transferred from one affiliate to another. User networks may be classified by organization, geographical regions, language, and so on. For example, networks may include Seattle area network, Microsoft employee network, Chinese network, and so forth. The intersection of the three above-mentioned networks (Seattle area, Microsoft, and Chinese) is also a network with Chinese employees working at Microsoft, located in the Seattle area. Each network or sub-network may have its own catalog, trust model, privacy/security policy, and service policy. Each local affiliate, online service provider (business or individual), or user network may have its own catalog of items/assets.

In some embodiments, the group trial system provides a group service policy for each group. A service policy may include membership requirements, such as Newport High School student volunteer club members. The service policy may also include a minimum number and maximum of group members required for the service. In some cases, a group may have only one member, which is equivalent to the conventional or current system. However, typically the policy will specify multiple members, creating the type of social network among members of the group described herein, and enhancing the product trial experience for all of the members. At some time, the group may be in a pre-group phase during which the group is forming and does not yet have its final number of members. Other service policy information may include credit card requirements, an allowed usage/trial period (e.g., seven days) before the trial expires and the member passes the item to the next member, and so forth.

The group trial system provides group management within a group. A group may have its own scheduling queue that specifies how trial item or items rotate within the group. A group may also have associated hierarchy, such that one group member or multiple group members are designated as group leads or power users with higher permissions than normal members do to manage the group. A group lead can invite more members to the group, and manage the group sharing and scheduling. Any change or event will send email or message alerts to all involved users. Joining users may require approval by the group lead based on the service policy.

The group trial system also provides various notifications and alerts to users of the system. For example, the system may email, text message, send push notifications (e.g., to mobile devices like smartphones and tablet computers), or provide other forms of notifications of significant events. For example, a member that currently is trying a product may receive a due date notification when the time for the trial is near expiration so that the member can pass the item to the next member. The system may also notify members when a change is made to the group (e.g., by a group lead). Members may be notified of new members joining the group, members leaving the group, changes in scheduling, new products available for the group to try, and so forth. The system may also provide communication between members of the group, such as for a member currently trying a product to discuss where to meet to pass the product to the subsequent member that will try the product.

A group can be classified as public, semi-public, or private in terms of public visibility. A public group can be listed and visible to everyone in the network. Everyone can join a public group without approval. Everyone in the network can apply to a semi-public group, but needs approval (e.g., by group leads) to join. A private group is not listed and is invite only. The group trial system also manages group internal privacy. Details about each group member that are exposed to non-members can be hidden or open partially or fully. Details about other members to an existing group member within the same group can be hidden or open partially or fully.

The group trial system includes a trust model for ensuring the security of items placed within groups for trial. The item could be lost by theft or broken. Trust can be secured by using a credit card charge at the outset of a trial. However, such a charge may create a severe barrier to a free service. As a result, the system also provides trust models based on no credit card requirement. Trust may be rated with different levels. The term trusted in this context means that the item could be checked-out and checked-in safely. Trust can be inherited by an unknown identity if associated with a trusted identity or invited by a trusted identity. Trust may be affected by and associated with a service provider, affiliate, and item.

In some cases, the group is a trusted network. For example, a Microsoft employee network may be a trusted network by a local affiliate for Microsoft product trials. However, the same network may not be trusted by a jewelry store for a $10K jewelry trial. If a network is trusted, every member of the network is trusted. That means that the item can be safely checked-out without credit card or other restrictive requirements. If a group lead is fully trusted by the system or the service provider, an asset can be checked out to him or her even though the group has no member yet. This group is called as pre-grouping. He or she can invite members afterwards and they will be trusted. Any friend invited or approved by the group lead, or joining from a trusted network is also a trusted group member. If all members are trusted members, the group is trusted for the service. With such a trust model, items can be quickly tried or borrowed without credit card requirements, where appropriate.

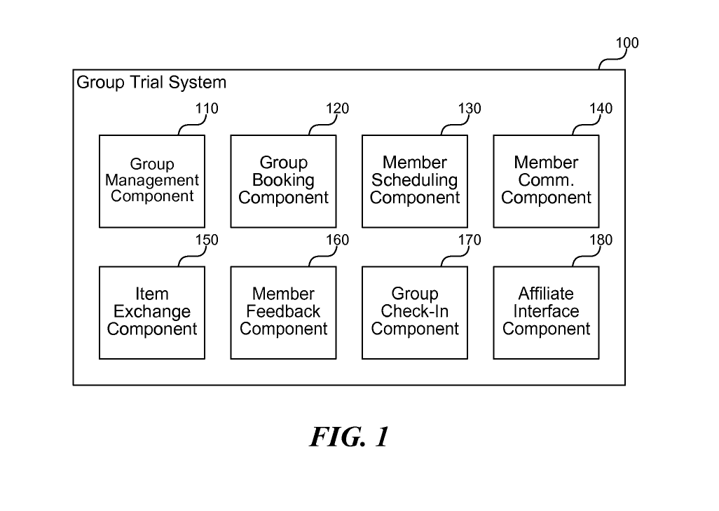

FIG. 1 is a block diagram that illustrates components of the group trial system, in one embodiment. The system 100 includes a group management component 110, a group booking component 120, a member scheduling component 130, a member communication component 140, an item exchange component 150, a member feedback component 160, a group check-in component 170, and an admin interface component 180. Each of these components is described in further detail herein. Although shown as logical components herein, those of ordinary skill in the art will recognize that the following components may be implemented in combination in one or more modules or split into separate modules as is most efficient for implementation.

The group management component 110 manages a group definition for each group of members recognized by the system, wherein the group definition identifies one or more members of the group and a scheduling policy for the group. The group definition may also include a service policy, identification of one or more group leads, one or more permissions for sharing data, and so forth. The service policy may include membership requirements for joining the group, a minimum and maximum number of group members allowed in the group, and so on. The group management component 110 manages prospective members joining the group, and may send notification to group leads (if the group is not public or open) to approve new members. The component 110 also handles members that leave the group, including ensuring that any trial items held by that member are returned and rescheduled for another group member to try. The permissions associated with the group may determine which members can perform certain activities, which data (such as reviews, profile information of members, and so forth) is shared and to whom, and so on. The group management component 110 may expose an application programming interface (API) or user interface (UI) for creating a new group, inviting potential members to the group, and managing the group.

The group booking component 120 books an item for trial use by the members of the group. In some cases, a group lead may identify one or more products of interest to the group and book the products on behalf of the group. The process of booking the item may include providing credit card or other identifying and securing information, and results in delivery of the item to one of the group members. In some cases, a group lead books the item, and schedules the item for delivery to a group member. After booking, once the item is available for delivery to the group, the item is delivered to the group. Once the group receives the item then the item is checked out to the group. The group booking component 120 may manage multiple instances of items available for trial as well as multiple groups that would like to try instances of the items. The group booking component 120 may schedule items for delivery to particular groups (e.g., in rotation or other scheme) when items are more limited than requests for the items. Ultimately, an item is delivered to one of the group members by an affiliate, partner, an operator of the system 100, a previous group, or some other party. Items may be delivered via mail, pickup, in-person exchange, and so forth.

The member scheduling component 130 manages a schedule indicating which group member will hold the item for trial use at which time according to the group's scheduling policy. For a scheduling policy that provides a threshold fixed time for each member to try the item, the component 130 may schedule each member of the group in turn for the provided threshold fixed time (e.g., seven days). In some cases, a member may request to return an item early and the component 130 may adjust the schedule to allow the remaining members to try the item sooner, or for one member to try the item longer (using a portion of the returning member's time). The system 100 allows for a flexible definition of group scheduling policy so that groups can schedule trials in a manner that is most suitable for them. For some trials, the system 100 gives control over scheduling policy to a provider of an item to meet particular goals of the provider. The order in which members of a group receive an item may be determined by the system 100, by group leads, by affiliates/providers, or in any manner suitable to a particular implementation of the system 100. Any waiting member can cancel or group leads can help to cancel. Some implementations may have concepts such as seniority where some members are entitled to receive the item for trial use sooner (e.g., based on past performance, points earned by giving feedback, paying to have an early position, and so forth). In typical cases, the trial order is based on a first come first served policy. Then based on members' trial urgency, passing conveniences, or other considerations, the group lead or other member may change the order. Group leads can change the order of member trials and change trial duration (or checkout/check-in data/time for some members).

The member communication component 140 facilitates communication between group members to arrange for exchange of the item for trial use in accordance with the scheduling policy. Communication can also occur for other purposes, such as messages, comments, help, and reviews shared between members. Communication can be one-to-one between members or may be one-to-many to the group (or across groups). Other members may reply to help one or more members. Members may discuss where and when to drop off the item, using various modes of communication tracked by the system 100, such as email, text message, push notifications, postal mail, and so forth. The system 100 may include an awareness of a calendar associated with each member, so that the system 100 can suggest dates, times, and places where there is overlap among members. For example, if two members will be at the same coffee shop at the same date and time, the system 100 may suggest an exchange of the item at that time.

The item exchange component 150 manages member check-in and checkout of the item for trial use and provides the system with an accounting of which member has the item at any given time. When a returning user successfully delivers the item to a subsequent user, the returning user may visit a user interface of the system 100 (e.g., a website, mobile application, or other interface) to indicate that the item has been delivered to the subsequent user. In some embodiments, the system receives an indication from the returning user specifying how the item was exchanged (e.g., in person, by mail, and so on), as well as any available tracking information. This constitutes checking the item in by the returning user. In some cases, the returning user may return the item to a common location (e.g., a group headquarters or meeting place), and the subsequent user may later obtain the item from there or be delivered the item by a group lead or group delivery service.

In some embodiments, check-in has three scenarios. The first is passing to the next waiting user or returning the item back to the group lead. In this scenario, check-in/checkout occurs at the same time. The current user checks in and the next user automatically checks out. This can be done automatically according to schedule, or manually initiated by either member of the group. The other user may confirm it or may not. In addition, a group lead or either of the two members can make corrections after the passing date is over. The second scenario is check-in in place. In this scenario, there is no waiting user and no need to return the item back to a group lead or local affiliate. The current user checks in indicating that he or she is done, but he or she is holding the item ready for next action. The “place” in this scenario could be the user's own place or a designated other place for checking in the item. The third scenario is a need to return the item back to a local affiliate or cross group. In this scenario, the member with the item will first check in in place indicating that he is ready to return or check in for the group. Then he or she will do the group check-in. This makes the system far more personal than traditional system that required the involvement of a professional and often a visit to a dedicated location to obtain items. The system also eliminates traditional dedicated storage for inventory, because items are held by group members until further exchange.

In some embodiments, the subsequent user performs a corresponding checkout process to indicate that the subsequent user has received the item. In the case of the first member of the group receiving the item, the member may go through a checkout process without a prior check-in from another member. The checkout process may include a user interface that the subsequent member visits to indicate that the item has been received, along with any related information such as how the item was received, the condition the item was in, and so forth. The item exchange component 150 allows the system 100 to know where an item is and which member is currently responsible for the item, and for providers of items to know how well items are making their way through trials.

The member feedback component 160 receives feedback from group members indicating how well the members liked the item that was tried. The system 100 may provide a user interface through which other users can view reviews or other forms of feedback so that users of the system 100 can share information with each other during trials of items. The member feedback component 160 may also provide a forum through which group members can ask questions within their group or to all users of the system 100. In this way, users share knowledge and gain comfort with items being tried by helping one another to successfully setup and use the items. Feedback may also include private feedback to manufacturers or service providers. Such feedback can help to improve the products or services. This feedback may be provided by the manufacturers own employees that are trying the product, partners, early adopters, or anyone who is motivated to do so. Feedback may also include private or public feedback to local affiliates a system operator to help improve the services.

The group check-in component 170 handles return of the item for trial use after the scheduled group members have each had an opportunity to try the item. In some cases, the last group member may return the item to a common location (e.g., ship it back to the provider, take it to a local retailer store, or other). In other cases, the last group member may return the item to a member of the next group. The group check-in component 170 accounts for the transition in responsibility for an item away from the group and to another group or back to the provider of the item. In some cases, a group trial may be followed by one or more of the group members purchasing the item to keep on a more permanent basis. In such cases, group members may have the option of receiving the actual instance of the item they tried back, sometimes for a discount or other consideration. For some types of items, the group may purchase the item to share and the item may then rotate among group members after the trial period is complete.

The admin interface component 180 provides an interface through which providers of items for trial use can specify items that are available and receive one or more reports related to ongoing item trials. The interface may also be used to order more item instances or assets. Manufacturers, partners, sponsors, affiliates, an operator of the system, or others may use the admin interface. Each provider may maintain a catalog of items with the system 100, and may use the affiliate interface to upload and update the catalog with item details from time to time. The system 100 may also provide reports to providers, such as how many users of the system 100 have tried an item, feedback (either in detail or summary form) about the item, questions users have had about the item, how many instances of the item have been sold as a result of trials through the system 100, and so forth. The affiliate interface component 180 may provide a website, mobile application, other application, API, or other way for providers to interact with the system 100.

The computing device on which the group trial system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

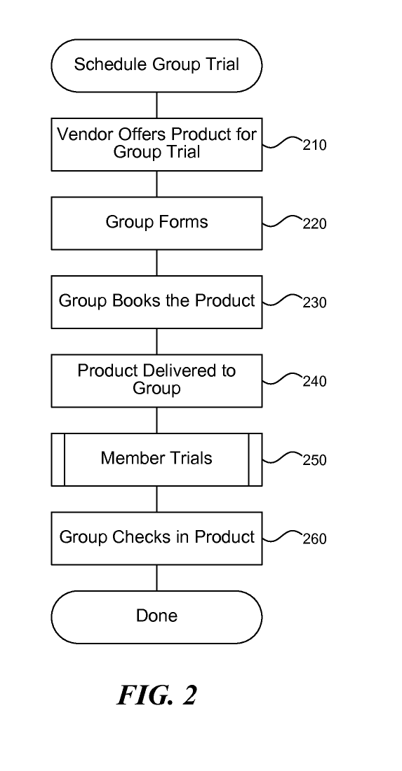

FIG. 2 is a flow diagram that illustrates processing of the group trial system to schedule a group trial of an item, in one embodiment. Beginning in block 210, the system receives an offer from a product provider to offer a product for a group trial. The system may provide an interface, such as a website, through which the product provider specifies information about the product. In response, the system places the product in a catalog of products available for trial. Groups can then access the catalog to select products to try. A particular product provider may provide one or many products for trial at the same time. The provider may also specify how many instances of each product are available to groups to try, so that the provider can limit how many products are in circulation for trial purposes at any given time.

Continuing in block 220, the system receives information defining one or more groups of users wherein the groups will share one or more trial products within the groups. Groups may be formed before any products are available or a group may form as a direct result of a community's interest in a particular product. Although shown here serially for ease of illustration, the formation of groups may happen in parallel or separately from the process for scheduling a group trial.

Continuing in block 230, the system receives a request to book the product for a group trial on behalf of a requesting group. The booking typically assigns an instance or asset (or multiple assets) of the product to the group, waiting in a queue or queues). In some embodiments, a group lead books the product on behalf of the group. In some groups, any group member may identify a product and book the product on behalf of the group. Other groups may have a democratic or other process whereby the group takes a poll to identify products to try. In some embodiments, the group requests any product and the system automatically chooses a product to try from the available catalog of products with offers from product providers.

Continuing in block 240, the system schedules the requested product to be delivered to the requesting group. This step may deliver and check out the asset or assets to the group. The physical delivery and check-out may include a few states (e.g., “delivery ready”, “in transit”, “delivered”, and so forth). The check out or delivery of the asset may be from another group to the requesting group or from an affiliate to the requesting group. Delivery may occur by shipping the product for trial through a common carrier (e.g., USPS, UPS, FedEx, and the like). Delivery may also occur by negotiating with the group lead or other group member to identify a convenient time and place for in person pick up of the product. In some cases, a product provider may want to provide an initial demonstration to the first group member that that group member can later pass on to other group members. Thus, the product provider may invite the group leader in to pick up the product in a showroom or other facility. In some embodiments, the system coordinates delivery of the product from a member of another group that previously tried the product to a member of the requesting group.

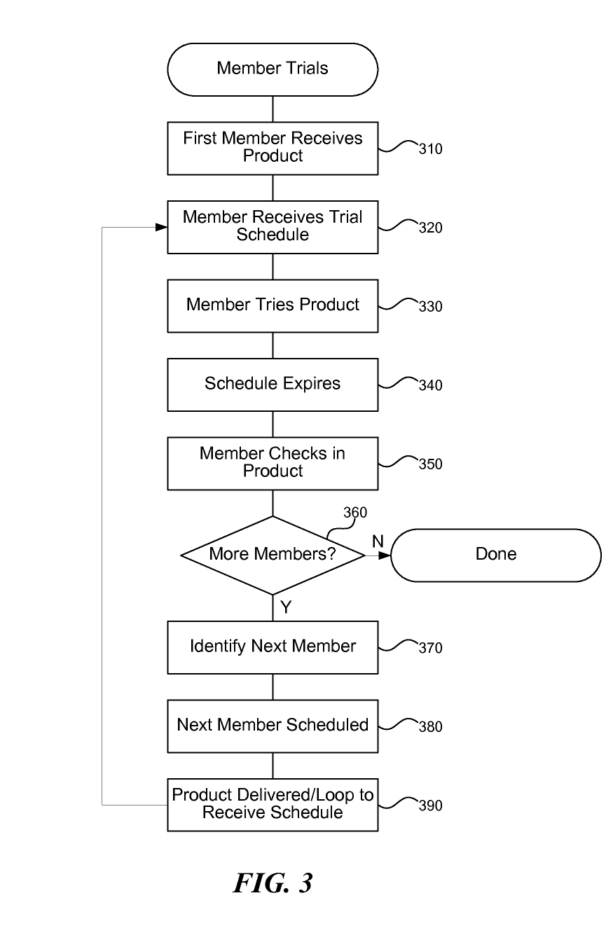

Continuing in block 250, the system schedules and circulates the requested product among the members of the requesting group. Groups and/or the system may define a group scheduling policy for each group that governs how long trials last, what order the product passes between members, how the product passes between members, and so forth. The processing of the system to manage exchange of a trial item between group members is described in further detail with reference to FIG. 3.

Continuing in block 260, after each of the members of the requesting group has had an opportunity to try the requested product, the system receives a request to check the product back in to the product provider on behalf of the group. In some cases, the product asset may be returned back or passed to next group, at any time, depending on request or trial policy. For example; the asset may be broken and need to return back ASAP even though some members have not tried the asset yet. In such cases, the group lead may end the trial early. A group lead or the last group member that tried the product may visit a user interface of the system to request check in of the product on behalf of the group. Check in may include the system instructing the checking in user where to drop off or deliver the product to complete the check in. Just as the product was delivered to the group, delivery to return the product from the group may include shipping, drop off in person to the product provider, or delivery to a member of another group that will try the product. In some cases, a member of the group may purchase the product so that check in includes delivering the product to that member rather than back to the product provider. After block 260, these steps conclude.

For some types of items (e.g., consumables or short-lived items), there may not be a group check-in or return. In such trials, there is no passing from one member to another. The group lead gets the items and distributes the items offline to the members. Each member just has a checkout event indicating that he or she has received his or her shares or instances within the defined schedule.

FIG. 3 is a flow diagram that illustrates processing of the group trial system to manage exchange of a trial item between members of the same trial group, in one embodiment. Beginning in block 310, the system delivers the trial item to a first member of a group that is designated to receive the item. The group may have an internal structure or policy that specifies which member receives the trial item first. In some cases, that member will be a group lead or other designated group member. There are two transactions for the first member when he or she gets the product. The first transaction is group checkout and the second is member checkout. He or she can confirm the group checkout and his personal checkout (even though the dates or times can be different). The first member typically is the lead. However, it could be any member who is more convenient to pick up or obtain the item via delivery. The trial item may be any product that a product provider wants to provide for users to try in their own environment, and may include electronic gadgets, healthcare products, green energy products, products typically sold in retail stores, products typically sold via mail order, or any other types of products that users might want to try before purchasing. The system may deliver the product in a variety ways as described further herein, such as mail, in person pickup, delivery from another user of the system (e.g., a member of another group or designated delivery member), and so forth.

Continuing in block 320, the system sends information describing a schedule for the trial to the member of the group, which includes a time that the member has for trying the trial item. In most cases, a member can see all other waiting members and their estimated schedules (which can be changed by configuration), with dependency on each other, based on trial policy and most updated trial schedules. The estimated schedules exist and constantly update since the product is booked for the group. The schedule may indicate a duration, expiration day, or other time specification that informs the member how long the trial will last. The system manages a schedule for passing trial items between group members and adherence to the schedule may be important to complete a trial under constraints placed by the product provider, system operator, group lead, or other party. In some embodiments, the system provides penalties for failure to meet the schedule, such as overdue fees or penalties if a user of the system keeps the trial item beyond his or her time. In some cases, failure to adhere to the trial schedule may cause a member to be removed from a group such that the member cannot participate in future product trials. The trial schedule may also indicate to the member who will next receive the trial item, so that the current member can communicate with the next member to arrange for exchange of the trial item.

Continuing in block 330, the system waits while the member tries the item during the member's scheduled time for trying the item. Trying the product may include the member using the product in his or her own home, workplace, or other environment so that the member can get a clear understanding of how the product will work for the member and suit the member's needs. The system may provide the member with a sufficient duration (e.g., a few minutes, a week, a month, 90 days, or other time) for trying the product to gain familiarity with the product.

At any point from the time of receiving the product to sometime after the member's trial period expires, the member may leave feedback about the product (not shown). Any time after receiving the product, he or she can write feedback or reviews as an experienced trial member. After purchase, the member can writes feedback as a buyer. Before trial, he or she can provide feedback as a non-trial user. Feedback may include directly communicating with another member, leaving feedback in a public or shared space where other trial users can see the feedback, communicating feedback to a group lead, communicating feedback to the product provider, and so forth. The feedback may help other users of the system in their trial of the product and may help product providers to improve the product.

Continuing in block 340, upon expiration of the member's scheduled time for trying the item or upon receiving an indication from the member that the member is done trying the item, the system notifies the member that the trial for that member is complete. In addition, the system may have previously notified the member with a reminder that expiration is coming. The reminder may notify the next waiting member, and may also be sent to the group lead. The system may send the member an email, text message, voicemail, push notification, or other form of communication to let the member know that the trial has expired for that member. The system may also provide the member with instructions for checking the trial item back in to the product provider or other party. In some embodiments, the member transfers control of and responsibility for the item by delivering the trial item to another user of the system (e.g., a next member in the member's own group or a member of another group).

Continuing in block 350, the system receives an indication that the member has checked in the trial item and may include delivering the trial item to a designated location. For example, the system may receive a tracking number of a shipment of the trial item or an indication from a second member that the first member transferred the trial item to the second member successfully. In some embodiments, the system may receive information from a third party, such as a retail location or local affiliate, indicating that the item has been returned by the member and is in the possession of the retail location.

Continuing in decision block 360, if the system determines that there are more members in the group waiting to try the trial item, then the system continues at block 370, else the system completes. The system manages a list of each of the members of each group, as well as a group scheduling policy that determines an order in which members of the group will receive trial items. Each group may have multiple lists tracked by the system. For example, a list of past users (trialed), current user (typically just one user), and waiting users. A list may also include invited (not accepted yet) or applying users (not approved yet). The system consults this list to determine which member will next receive the trial item when a preceding member checks in the trial item.

Continuing in block 370, the system identifies a next member of the group designated to receive the trial item. The set of members of the group forms a social network of users that may be related by one or more membership criteria for entry into the group. For example, the members may share a workplace, church, social group, neighborhood, family, or other relation. By passing trial items between related members of groups, the system enhances efficiency for the product provider and increases positive word of mouth between trial participants. From the product provider's perspective, each group to which the provider provides a trial item represents potentially an order of magnitude or greater degree of influence. For example, in a group of 10 users, by providing the trial item to one of the members, the provider exposes 10 people to the product for the same or similar level of effort. Likewise, because members of the group have something in common and may encounter one another for other reasons in daily life, the members will share positive information about the product during the trial often with a positive effect on product sales.

Continuing in block 380, the system schedules the identified next member to receive the trial item. This may include directing the first member to deliver the product to the next member. In some embodiments, a communication phase occurs between the first and next group member, during which the members arrange a convenient time and place for exchanging the trial item. The communication phase may include one or more emails or other forms of communication between the members to arrange for the exchange. In many cases, the exchange can take place at a location and time that is already mutually convenient for the members, such as a meeting that the members regularly attend. In this way the trial item moves between users of the system at least cost and higher convenience than is possible with traditional systems.

Continuing in block 390, the system loops to block 320 to inform the identified next member of the trial schedule. During this step, the product goes through checkout and delivery to the next member. At this point, the process continues for each member in the group until each of the members of the group has had an opportunity to try the trial item or the trial has stopped based on other requests or conditions. In some cases, a member of the group may not want to try a particular item, and the system may provide a user interface through which group members can so indicate (or cancel). In such cases, the system removes the members requesting not to try the trial item from the scheduled rotation for the item. This allows the trial item to efficiently move to the next member that is interested in trying the item. The system continues in this manner until the system determines at block 360 that there are no more members of the group set to try the trial item. After block 390, these steps conclude.

From the foregoing, it will be appreciated that specific embodiments of the group trial system have been described herein for purposes of illustration, but that various modifications may be made without deviating from the spirit and scope of the invention. Accordingly, the invention is not limited except as by the appended claims.

I/We claim:

1. A computer-implemented method to schedule a group trial of an item, the method comprising:
receiving 210 an offer from a product provider to offer a product for a group trial, wherein a group trial occurs for each member of the group in an environment selected by one or more members;
receiving 220 information defining one or more groups of users wherein the groups will share one or more trial products within the groups;
receiving 230 a request to book the product for a group trial on behalf of a requesting group;
scheduling 240 the requested product to be delivered to the requesting group;
scheduling 250 and circulating the requested product among the members of the requesting group; and
after each of the members of the requesting group has had an opportunity to try the requested product, receiving 260 a request to check the product back in on behalf of the group,
wherein the preceding steps are performed by at least one processor.

2. The method of claim 1 wherein receiving the offer comprises receiving a specification from the provider indicating how many instance of each product are available to groups to try, so that the provider can limit how many products are in circulation for trial purposes at any given time.

3. The method of claim 1 wherein receiving information defining one or more groups comprises forming a group as a direct result of a community's interest in a particular product.

4. The method of claim 1 wherein receiving information defining one or more groups comprises identifying at least one group formed in advance of identifying a product for the group to try.

5. The method of claim 1 wherein receiving the request to book the product comprises receiving the request from a group lead that books the product on behalf of the group.

6. The method of claim 1 wherein receiving the request to book the product comprises receiving a request from the group to have a product to try selected for the group and in response automatically choosing a product to try from an available catalog of products with offers from product providers.

7. The method of claim 1 wherein scheduling the requested product to be delivered comprises negotiating with a group member to identify a convenient time and place for in-person transfer of the product.

8. The method of claim 1 wherein scheduling the requested product to be delivered comprises inviting a group member in to pick up the product to receive training to use the product.

9. The method of claim 1 wherein scheduling the requested product to be delivered comprises coordinating delivery of the product from a member of another group that previously tried the product to a member of the requesting group.

10. The method of claim 1 wherein scheduling and circulating the requested product among the members of the requesting group comprises consulting a group scheduling policy defined for the requesting group that governs how long trials last, what order the product passes between members, and how the product passes between members.

11. The method of claim 1 wherein receiving the request to check the product back in comprises a last group member that tried the product accessing a user interface to request check in of the product on behalf of the group.

12. The method of claim 1 wherein receiving the request to check the product back in comprises instructing the checking in user where to drop off or deliver the product to complete the check in.

13. The method of claim 1 wherein in at least one trial each member receives an instance of the item that does not need to be returned, and wherein check in occurs by the user receiving and using the item.

14. A computer system for facilitating automated group trials of products and services, the system comprising:
a processor and memory configured to execute software instructions embodied within the following components;
a group management component 110 that manages a group definition for each group of members recognized by the system, wherein the group definition identifies one or more members of the group and a scheduling policy for the group;
a group booking component 120 that books an item for trial use by the members of the group;
a member scheduling component 130 that manages a schedule indicating which group member will hold the item for trial use at which time according to the group's scheduling policy;
a member communication component 140 that facilitates communication between group members related to the trial;
an item exchange component 150 that manages member check-in and checkout of the item for trial use and provides the system with an accounting of which member has the item at any given time; and
a group check-in component 170 that handles return of the item for trial use after the scheduled group members have each had an opportunity to try the item or the trial has ended early.

15. The system of claim 14 wherein the group definition further comprises at least one of a service policy, identification of one or more group leads, and one or more permissions for sharing data associated with the group.

16. The system of claim 14 wherein the group management component manages membership requirements that restrict who can join the group to become a member.

17. The system of claim 14 further comprising a member feedback component that receives feedback from group members indicating how well the members liked the item that was tried.

18. The system of claim 14 further comprising an admin interface component that provides an interface through which providers of items for trial use can specify items that are available and receive one or more reports related to ongoing item trials.

19. A computer-readable storage medium comprising instructions for controlling a computer system to manage exchange of a trial item between members of a group that tries the item together, wherein the instructions, upon execution, cause a processor to perform actions comprising:
delivering 310 the trial item to a first member of a group that is designated to receive the item;
sending 320 information describing a schedule for the trial to the member of the group, which includes a time that the member has for trying the trial item;
waiting 330 while the member tries the item during the member's scheduled time for trying the item;
upon expiration of the member's scheduled time for trying the item or upon receiving an indication from the member that the member is done trying the item, notifying 340 the member that the trial for that member is complete;
receiving 350 an indication that the member has checked in the trial item by delivering the trial item to a designated location;
if there are more members in the group waiting to try the trial item, identifying 370 a next member of the group designated to receive the trial item; and
scheduling 380 the identified next member to receive the trial item.

20. The medium of claim 19 wherein trying the item for a member comprises allowing the member to use the product in the member's own home, workplace, or other environment so that the member can get a clear understanding of how the product will work for the member and suit the member's needs.
